(19) United States
(12) Patent Application Publication
(10) Pub. No.: US 2012/0062782 A1
(43) Pub. Date: Mar. 15, 2012

(54) OPTICAL IMAGING LENS ASSEMBLY

(75) Inventor: Hsin Hsuan Huang, Taichung City (TW)

(73) Assignee: LARGAN PRECISION CO., LTD., Taichung City (TW)

(21) Appl. No.: 12/955,544

(22) Filed: Nov. 29, 2010

(30) Foreign Application Priority Data
Sep. 15, 2010 (TW) 099131301

(51) Int. Cl. H04N 5/225; G02B 13/18

(52) U.S. Cl. 348/340; 359/715; 348/E05.024

(57) ABSTRACT

This invention provides an optical imaging lens assembly comprising, in order from an object side to an image side: a first lens element with positive refractive power having a convex object-side surface; a second lens element with negative refractive power having a convex object-side surface and a concave image-side surface; a third lens element having a convex image-side surface, the edge of the image-side surface of the third lens element within the clear aperture diameter tends to the image side; a fourth lens element with negative refractive power having a concave image-side surface; a first stop disposed between an object and the first lens element; and a second stop disposed between the second and fourth lens elements. With the aforementioned arrangement of optical lenses, the total track length of the optical imaging lens assembly can be reduced effectively, the sensitivity of the optical lens assembly can be attenuated, and the image quality can be improved.

### CROSS-REFERENCE TO RELATED APPLICATIONS

This non-provisional application claims priority under 35 U.S.C. §119(a) on Patent Application No(s). 099131301 filed in Taiwan, R.O.C. on Sep. 15, 2010, the entire contents of which are hereby incorporated by reference.

### BACKGROUND OF THE INVENTION

1. Field of the Invention

The present invention relates to an optical imaging lens assembly, and especially in a compact optical imaging lens assembly used in portable electronic devices.

2. Description of the Prior Art

In recent years, with the popularity of compact photographing lens assembly, the demand for compact imaging modules is increasing, and the sensor of general photographing lens assembly is none other than CCD (Charge Coupled Device) or CMOS (Complementary Metal Oxide Semiconductor). Furthermore, as advances in semiconductor manufacturing technology have allowed the pixel size of sensors to be reduced and electronic products have become more compact and portable, there is an increasing demand of mainstream for compact optical imaging lens assembly featuring with better image quality.

Generally, the conventional optical lens assembly for compact photographing lens assembly, such as the one disclosed in U.S. Pat. No. 7,145,736, is of a triplet type comprising, in order from the object side to the image side: a first lens element with positive refractive power; a second lens element with negative refractive power; and a third lens element with positive refractive power. However, the three-element lens has become insufficient for a high-end imaging lens module due to the reduction in the pixel size of sensors and the increasing demand for lens assembly featuring better image quality.

U.S. Pat. No. 7,365,920 has disclosed a four lens element assembly, wherein two spherical-surface glass lenses serving as the first and second lens elements are adhered together to form a doublet for correcting the chromatic aberration. Such an arrangement of optical elements, however, has the following disadvantages: (1) the degree of freedom of the lens assembly is curtailed due to the employment of excess number of spherical-surface glass lenses, thus the total track length of the lens assembly cannot be reduced easily; (2) the process of adhering glass lenses together is complicated in posing difficulties for manufacture.

Therefore, a need exists in the art for an optical imaging lens assembly that features simple manufacturing process and better image quality.

### SUMMARY OF THE INVENTION

The present invention provides an optical imaging lens assembly comprising, in order from an object side to an image side: a first lens element with positive refractive power having a convex object-side surface; a second lens element with negative refractive power having a convex object-side surface and a concave image-side surface; a third lens element having a convex image-side surface, and its edge of the image-side surface within the clear aperture diameter tends to the image side; a fourth lens element with negative refractive power having a concave image-side surface; a first stop disposed between an object and the first lens element; and a second stop disposed between the second and fourth lens elements; wherein the optical imaging lens assembly further comprises an electronic sensor for the image formation of object; a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is LS, half of an aperture diameter of the second stop is YS, a distance on the optical axis between the second stop and an object-side surface of an adjacent lens element relative to the object side of the second stop is DS, a distance on the optical axis between the object-side surface of an adjacent lens element relative to the object side of the second stop and the image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations: (ImgH-0.7LS)/ImgH<YS/ImgH<0.78, 0.1 <DS/DL<0.7, 0.63 <f3/f1<2.45, V1−V2>25.6, 0.15<T12/CT2<1.95, 0.67<f3/f<3.33.

The present invention provides another optical imaging lens assembly comprising, in order from an object side to an image side: a first lens element with positive refractive power having a convex object-side surface; a second lens element with negative refractive power having a convex object-side surface and a concave image-side surface; a third lens element with positive refractive power having a convex image-side surface on which at least one inflection point is formed; a fourth lens element with negative refractive power having a concave image-side surface; a first stop disposed between an object and the first lens element; a second stop disposed between the second and third lens elements; wherein the optical imaging lens assembly further comprises an electronic sensor for the formation of object; wherein a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is LS, half of an aperture diameter of the second stop is YS, a distance on the optical axis between the second stop and the object-side surface of an adjacent lens element relative to the object side of the second stop is DS, a distance on the optical axis between the object-side surface of an adjacent lens element relative to the object side of the second stop and the image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations: (ImgH-0.7LS)/ImgH<YS/ImgH<0.78, 0.1<DS/DL<0.7, 0.63<f3/f1<2.45, V1−V2>25.6, 0.15<T12/CT2<1.95, 0.67<f3/f<3.33.

With the aforementioned arrangement of optical lenses, the total track length of the optical imaging lens assembly can be reduced effectively, the sensitivity of the optical lens assembly can be attenuated, and the image quality can be improved.

In the present optical imaging lens assembly, the first lens element with positive refractive power provides the optical lens assembly positive refractive power so that the total track length of the lens assembly can be favorably reduced; the second lens element has negative refractive power so that the aberration generated by the first lens element with positive refractive power and the chromatic aberration of the optical lens assembly can be favorably corrected; the third lens element has positive refractive power so that the refractive power of the first lens element can be effectively distributed to attenuate the sensitivity of the optical lens assembly; the fourth lens element has negative refractive power so that the principal point of the optical imaging lens assembly can be positioned away from the image plane, thereby the total track length of the optical lens assembly can be favorably reduced for keeping compact.

The first stop is disposed between the object and the first lens element so as to favorably achieve the telecentricity and to reduce the total track length of the optical imaging lens assembly.

In the present optical imaging lens assembly, the first lens element has a convex object-side surface so that the refractive power thereof can be effectively enhanced, thereby reducing the total track length of the optical imaging lens assembly. The second lens element has a convex object-side surface and a concave image-side surface so that the aberration generated by the first lens element can be favorably corrected and the refractive power of the second lens element thereof can be effectively controlled to attenuate the sensitivity of the optical lens assembly. The third lens element has a convex image-side surface so that the positive refractive power thereof can be effectively enhanced, thereby the distribution of the refractive power of the assembly can be more in balance. The fourth lens element has a concave image-side surface so that the principal point of the optical lens assembly can be positioned away from the image plane, thereby the total track length of the optical lens assembly can be favorably reduced for keeping compact.

### BRIEF DESCRIPTION OF THE DRAWINGS

FIG. 1A shows an optical imaging lens assembly in accordance with a first embodiment of the present invention.

FIG. 1B is an enlarged view showing the edge of clear aperture diameter of the third lens element in accordance with the first embodiment of the present invention.

FIG. 1C shows the aberration curve of the first embodiment of the present invention.

FIG. 2A shows an optical imaging lens assembly in accordance with a second embodiment of the present invention.

FIG. 2B is an enlarged view showing the edge of clear aperture diameter of the third lens element in accordance with the second embodiment of the present invention.

FIG. 2C shows the aberration curve of the second embodiment of the present invention.

FIG. 3A shows an optical imaging lens assembly in accordance with a third embodiment of the present invention.

FIG. 3B is an enlarged view showing the edge of clear aperture diameter of the third lens element in accordance with the third embodiment of the present invention.

FIG. 3C shows the aberration curve of the third embodiment of the present invention.

FIG. 4 is TABLE 1 which lists the optical data of the first embodiment.

FIGS. 5A and 5B are TABLES 2A and 2B which list the aspheric surface data of the first embodiment.

FIG. 6 is TABLE 3 which lists the optical data of the second embodiment.

FIGS. 7A and 7B are TABLES 4A and 4B which list the aspheric surface data of the second embodiment.

FIG. 8 is TABLE 5 which lists the optical data of the third embodiment.

FIGS. 9A and 9B are TABLES 6A and 6B which list the aspheric surface data of the third embodiment.

FIG. 10 is TABLE 7 which lists the data of the respective resulting of the equations in accordance with the first, second and third embodiments.

FIG. 11 shows the relation between the clear aperture diameter and the included angle of the image-side surface of the third lens element in accordance with the first, second and third embodiments.

FIG. 12 illustrates the distances and relative locations represented by LS, YS, DS and DL.

### DETAILED DESCRIPTION OF THE PREFERRED EMBODIMENTS

The present invention provides an optical imaging lens assembly comprising, in order from an object side to an image side: a first lens element with positive refractive power having a convex object-side surface; a second lens element with negative refractive power having a convex object-side surface and a concave image-side surface; a third lens element having a convex image-side surface, and its edge of the image-side surface within the clear aperture diameter tends to the image side; a fourth lens element with negative refractive power having a concave image-side surface; a first stop disposed between an object and the first lens element; and a second stop disposed between the second and the fourth lens elements; wherein the optical imaging lens assembly further comprises an electronic sensor where the object is imaged; and wherein a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is

LS, half of an aperture diameter of the second stop is YS, a distance on the optical axis between the second stop and the object-side surface of an adjacent lens element relative to the object side of the second stop is DS, a distance on the optical axis between the object-side surface of an adjacent lens element relative to the object side of the second stop and the image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations: (ImgH-0.7LS)/ImgH<YS/ImgH<0.78, 0.1<DS/DL<0.7, 0.63<f3/f1<2.45, V1−V2>25.6, 0.15<T12/CT2<1.95, 0.67<f3/f<3.33.

When the relation of (ImgH-0.7LS)/ImgH<YS/ImgH<0.78 is satisfied, the aperture diameter of the stop can be controlled to shade the optical imaging lens assembly from unnecessary ambient light so that the image quality of the optical lens assembly can be improved, and also enables the optical lens assembly to maintain a satisfactory relative illumination.

When the relation of 0.1<DS/DL<0.7 is satisfied, the relative locations and distances between the second stop and its adjacent lens elements can be effectively controlled for facilitating the manufacture of the optical imaging lens assembly.

When the relation of 0.63<f3/f1<2.45 is satisfied, the refractive power of the optical imaging lens assembly can be effectively distributed, thereby the aberration of the optical lens assembly can be prevented from becoming too large.

When the relation of V1−V2>25.6 is satisfied, the chromatic aberration of the optical imaging lens assembly can be favorably corrected.

When the relation of 0.15<T12/CT2<1.95 is satisfied, the high order aberration of the optical imaging lens assembly can be favorably corrected. The satisfaction of the above relation also enables a proper disposition of lens elements.

When the relation of 0.67<f3/f<3.33 is satisfied, the the requirement of refractive power in the optical lens assembly can be effectively distributed to control the total track length of the optical lens assembly. The satisfaction of the above relation also prevents the refractive power of any single lens element from becoming too large so that the sensitivity of the optical lens assembly can be attenuated.

In the aforementioned optical imaging lens assembly, the edge of the image-side surface of the third lens element within the clear aperture diameter tends to the image side so that the aberration caused by the ambient light can be favorably corrected to improve the resolution in the edge.

In the aforementioned optical imaging lens assembly, it is preferable that the first stop is an aperture stop so as to favorably achieve the telecentricity of the optical lens assembly and to reduce the total track length of the optical imaging lens assembly.

In the aforementioned optical imaging lens assembly, it is preferable that at least one of the object-side and image-side surfaces of the second lens element is provided with at least one inflection point so that the ambient light can be corrected more effectively.

In the aforementioned optical imaging lens assembly, it is preferable that the fourth lens element is made of plastic material and at least one of the object-side and image-side surfaces thereof is aspheric. Preferably, at least one of the object-side and image-side surfaces of the fourth lens element is provided with at least one inflection point.

In the aforementioned optical imaging lens assembly, the radius of curvature of the object-side surface of the second lens element is R3, the radius of curvature of the image-side surface of the second lens element is R4, and they preferably satisfy the relation: 1.5<R3/R4<2.5. When the above relation is satisfied, the astigmatism of the optical lens assembly can be favorably corrected.

In the aforementioned optical imaging lens assembly, the radius of curvature of the object-side surface of the first lens element is R1, the radius of curvature of the image-side surface of the first lens element is R2, and they preferably satisfy the relation: −1<R1/R2<0. When the above relation is satisfied, the spherical aberration of the optical lens assembly can be favorably corrected.

In the aforementioned optical imaging lens assembly, the focal length of the first lens element is f1, the focal length of the optical imaging lens assembly is f, and they preferably satisfy the relation: 1.05<f1/f<1.18. When the above relation is satisfied, the distribution of the refractive power of the assembly can be more in balance, and thereby the total track length of the optical lens assembly can be effectively controlled for keeping the lens assembly compact. The satisfaction of the above relation also prevents the high order spherical aberration from becoming too large so that the image quality can be improved.

In the aforementioned optical imaging lens assembly, the distance on the optical axis between the object-side surface of the first lens element and the electronic sensor is TTL, half of the diagonal length of the effective pixel area of the electronic sensor is ImgH, and they preferably satisfy the relation: TTL/ImgH<2.0. The satisfaction of the above relation enables the optical imaging lens assembly to maintain a compact form so that it can be installed in compact and portable electronic products.

The present invention provides another optical imaging lens assembly comprising, in order from an object side to an image side: a first lens element with positive refractive power having a convex object-side surface; a second lens element with negative refractive power having a convex object-side surface and a concave image-side surface; a third lens element with positive refractive power having a convex image-side surface on which at least one inflection point is formed; a fourth lens element with negative refractive power having a concave image-side surface; a first stop disposed between an object and the first lens element; a second stop disposed between the second and third lens elements; the optical imaging lens assembly further comprises an electronic sensor where the object is imaged; and wherein a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is LS, half of an aperture diameter of the second stop is YS, a distance on the optical axis between the second stop and the object-side surface of an adjacent lens element relative to the object side of the second stop is DS, a distance on the optical axis between the object-side surface of an adjacent lens element relative to the object side of the second stop and the image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations: (ImgH-0.7LS)/ImgH<YS/ImgH<0.78, 0.1<DS/DL<0.7, 0.63<f3/f1<2.45, V1−V2>25.6, 0.15<T12/CT2<1.95, 0.67<f3/f<3.33.

When relation of (ImgH-0.7LS)/ImgH<YS/ImgH<0.78 is satisfied, the aperture diameter of the stop can be controlled to favorably eliminate unnecessary ambient light so that the image quality of the optical lens assembly can be improved. The satisfaction of the above relation also enables the optical lens assembly to maintain a satisfactory relative illumination.

When the relation of 0.10<DS/DL<0.70 is satisfied, the relative locations and distances between the second stop and its adjacent lens elements can be effectively controlled to facilitate the lens assembly of the optical imaging lens assembly.

When the relation of 0.63<f3/f1<2.45 is satisfied, the refractive power of the optical imaging lens assembly can be effectively distributed, thereby the aberrations of the optical lens assembly can be prevented from becoming too large.

When the relation of V1−V2>25.6 is satisfied, the chromatic aberration of the optical imaging lens assembly can be favorably corrected.

When the relation of 0.15<T12/CT2<1.95 is satisfied, the high order aberration of the optical imaging lens assembly can be favorably corrected. The satisfaction of the above relation also enables a balanced disposition of the lens elements. Preferably, T12 and CT2 satisfy the relation: 0.15<T12/CT2<0.80.

When the relation of 0.67<f3/f<3.33 is satisfied, the the requirement of refractive power in the optical lens assembly can be effectively distributed to control the total track length of the optical lens assembly. The satisfaction of the above relation also prevents the refractive power of any single lens element from becoming too large so that the sensitivity of the optical lens assembly can be attenuated.

In the aforementioned optical imaging lens assembly, it is preferable that the first stop is an aperture stop.

In the aforementioned optical imaging lens assembly, it is preferable that at least one of the object-side and image-side surfaces of the second lens element is provided with at least one inflection point. Preferably, at least one of the object-side and image-side surfaces of the fourth lens element is provided with at least one inflection point.

In the aforementioned optical imaging lens assembly, the radius of curvature of the object-side surface of the second lens element is R3, the radius of curvature of the image-side surface of the second lens element is R4, and they preferably satisfy the relation: 1.5<R3/R4<2.5. When the above relation is satisfied, the astigmatism of the optical lens assembly can be favorably corrected.

In the aforementioned optical imaging lens assembly, the focal length of the first lens element is f1, the focal length of the optical imaging lens assembly is f, and they preferably satisfy the relation: 1.05<f1/f<1.18. When the above relation is satisfied, the distribution of the refractive power of the assembly can be more in balance, and thereby the total track length of the optical lens assembly can be effectively controlled for keeping the lens assembly compact. The satisfaction of the above relation also prevents the high order spherical aberration from becoming too large so that the image quality can be improved.

In the present optical imaging lens assembly, the lens elements can be made of glass or plastic material. If the lens elements are made of glass, there is more freedom in distributing the refractive power of the optical lens assembly. If plastic material is adopted to produce the lens elements, the production cost will be reduced effectively. Additionally, the surfaces of the lens elements can be aspheric and easily made into non-spherical profiles, allowing more design parameter freedom which can be used to reduce the aberration and to further decrease the number of the lens elements. Consequently, the total track length of the optical imaging lens assembly can be effectively reduced.

In the present optical imaging lens assembly, if a lens element has a convex surface, it means the portion of the surface in proximity to the optical axis is convex; if a lens element has a concave surface, it means the portion of the surface in proximity to the optical axis is concave.

A stop is a light shielding element disposed in a lens assembly. The light shielding element having an aperture which is configured to control the amount of incident light functions as an aperture stop for controlling the amount of light entering the lens assembly or as a stop for correcting borderline light. The stop is disposed in a location where it has a minimal aperture diameter.

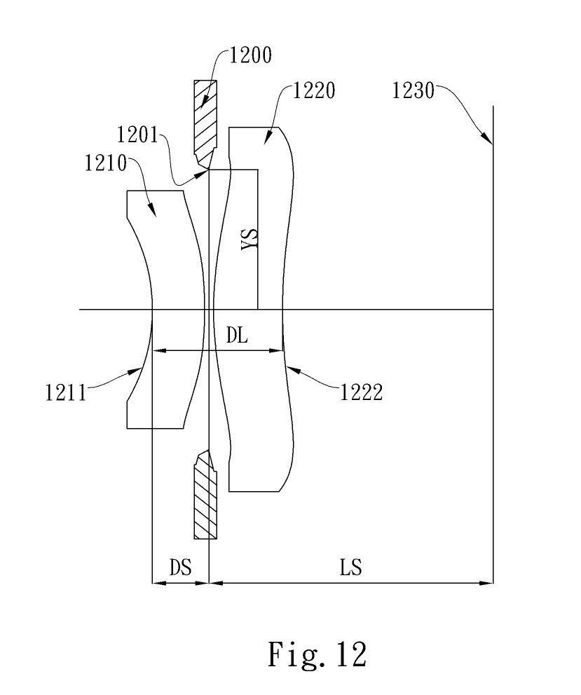

In the present optical imaging lens assembly, the stop is a light shielding element configured such that it shades the optical lens assembly from unwanted light to enhance the focusing power while enabling the optical lens assembly to maintain a satisfactory relative illumination. The stop as a tangible object is disposed in a location where it has a minimal aperture diameter and influences the optical path. FIG. 12 illustrates the distances and relative locations represented by LS, YS, DS and DL. The stop 1200 is a tangible object with a thickness. The stop 1200 is disposed in a location 1201 where it has a minimal aperture diameter and influences the optical path. LS is the distance on the optical axis between the stop 1200 and the electronic sensor 1230; YS is half of the aperture diameter of the stop 1200, i.e. the distance between the location 1201 and the optical axis; DS is the distance on the optical axis between the stop 1200 and the object-side surface 1211 of the adjacent lens element 1210 relative to the object side of the stop 1200; DL is the distance on the optical axis between the object-side surface 1211 of the adjacent lens element 1210 relative to the object side of the stop 1200 and the image-side surface 1222 of the adjacent lens element 1220 relative to the image side of the stop 1200.

Preferred embodiments of the present invention will be described in the following paragraphs by referring to the accompanying drawings.

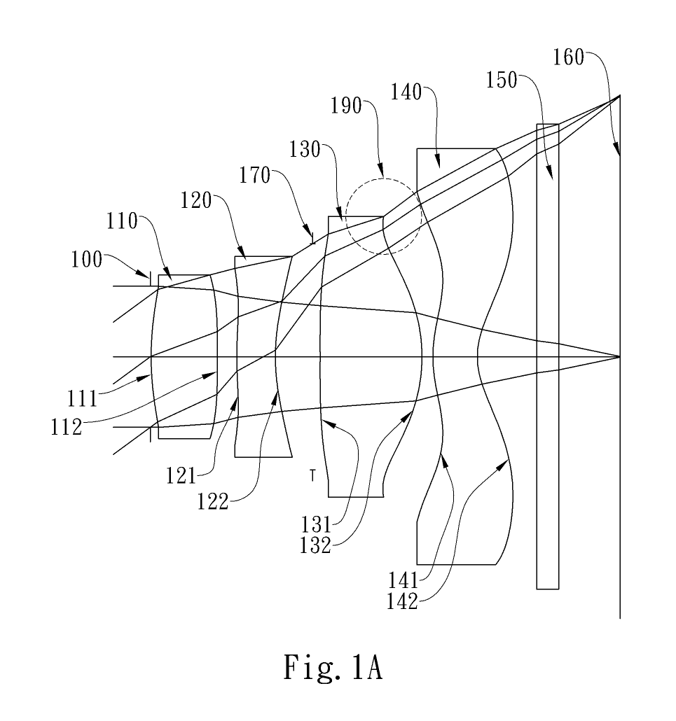

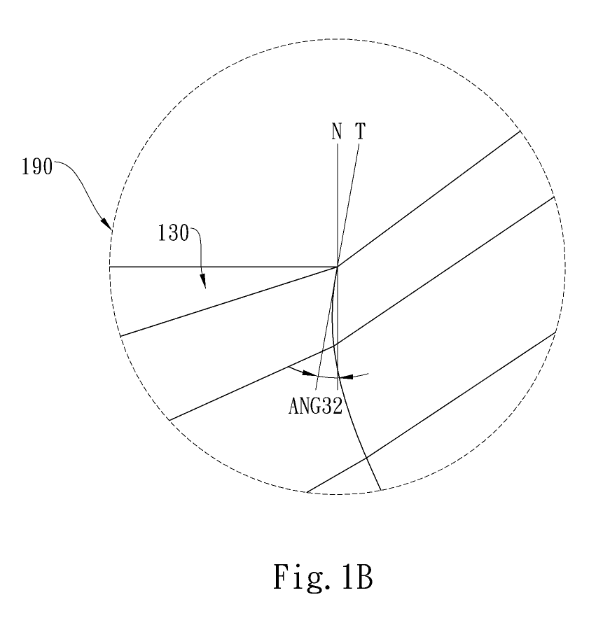

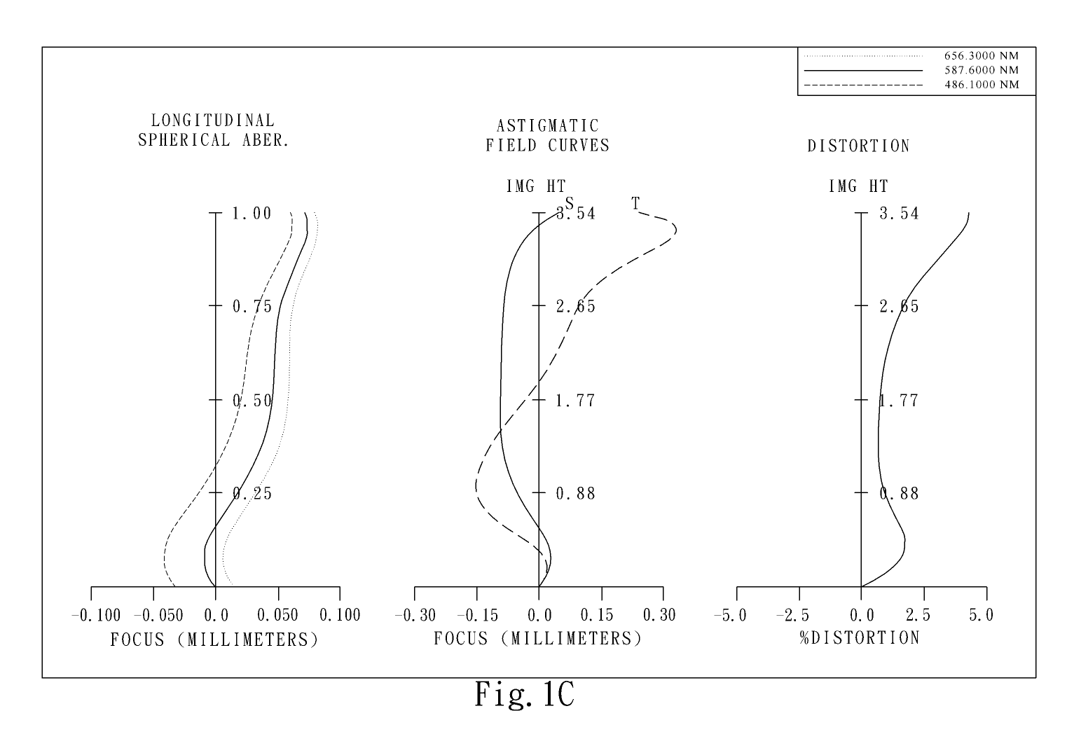

FIG. 1A shows an optical imaging lens assembly in accordance with a first embodiment of the present invention, and FIG. 1C shows the aberration curve of the first embodiment of the present invention. In the first embodiment of the present invention, there is provided an optical imaging lens assembly mainly comprising four lens elements, in order from an object side to an image side: a glass first lens element 110 with positive refractive power having a convex object-side surface 111 and a convex image-side surface 112, the object-side and image-side surfaces 111 and 112 thereof being aspheric; a plastic second lens element 120 with negative refractive power having a convex object-side surface 121 on which at least one inflection point is formed and a concave image-side surface 122, the object-side and image-side surfaces 121 and 122 thereof being aspheric; a plastic third lens element 130 with positive refractive power having a concave object-side surface 131 and a convex image-side surface 132, the object-side and image-side surfaces 131 and 132 thereof being aspheric, the edge of the image-side surface 132 of the third lens element 130 within the clear aperture diameter tends to the image side surface (see FIG. 1B and the following description); a plastic fourth lens element 140 with negative refractive power having a convex object-side surface 141 and a concave image-side surface 142, the object-side and image-side surfaces 141 and 142 thereof being aspheric and each of which being provided with at least one inflection point. The optical imaging lens assembly is also provided with an aperture stop 100 disposed between an object and the first lens element 110 and a second stop 170 disposed between the second lens element 120 and the third lens element 130. The optical imaging lens assembly further comprises an IR-filter 150 disposed between the image-side surface 142 of the fourth lens element 140 and an image plane 160; the IR-filter 150 is made of glass and has no influence on the focal length of the optical imaging lens assembly. Moreover, an electronic sensor is disposed at the image plane 160 where the object is imaged.

The equation of the aspheric surface profiles is expressed as follows:

$$X ( Y ) = ( {Y}^{2} / R ) / ( I + sqrt ( 1 - ( 1 + k ) * {( Y / R )}^{2} ) ) + {\sum }_{i} ( Ai ) * ( {Y}^{i} )$$

wherein:

X: the height of a point on the aspheric surface at a distance Y from the optical axis relative to the tangential plane at the aspheric surface vertex;

Y: the distance from the point on the curve of the aspheric surface to the optical axis;

k: the conic coefficient;

Ai: the aspheric coefficient of order i.

In the first embodiment of the present optical imaging lens assembly, the focal length of the optical imaging lens assembly is f, and it satisfies the relation: f=4.70 (mm).

In the first embodiment of the present optical imaging lens assembly, the f-number of the optical imaging lens assembly is Fno, and it satisfies the relation: Fno=2.40.

In the first embodiment of the present optical imaging lens assembly, half of the maximal field of view of the optical imaging lens assembly is HFOV, and it satisfies the relation: HFOV=36.3 (degrees).

In the first embodiment of the present optical imaging lens assembly, the Abbe number of the first lens element 110 is V1, the Abbe number of the second lens element 120 is V2, and they satisfy the relation: V1−V2=27.7.

In the first embodiment of the present optical imaging lens assembly, the distance on the optical axis between the first lens element 110 and the second lens element 120 is T12, the thickness of the second lens element 120 on the optical axis is CT2, and they satisfy the relation: T12/CT2=0.50.

In the first embodiment of the present optical imaging lens assembly, the radius of curvature of the object-side surface 111 of the first lens element 110 is R1, the radius of curvature of the image-side surface 112 of the first lens element 110 is R2, and they satisfy the relation: R1/R2=−0.09.

In the first embodiment of the present optical imaging lens assembly, the radius of curvature of the object-side surface 121 of the second lens element 120 is R3, the radius of curvature of the image-side surface 122 of the second lens element 120 is R4, and they satisfy the relation: R3/R4=2.02.

In the first embodiment of the present optical imaging lens assembly, the focal length of the first lens element 110 is f1, the focal length of the optical imaging lens assembly is f, and they satisfy the relation: f1/f=1.10.

In the first embodiment of the present optical imaging lens assembly, the focal length of the third lens element 130 is f3, the focal length of the optical imaging lens assembly is f, and they satisfy the relation: f3/f=0.96.

In the first embodiment of the present optical imaging lens assembly, the focal length of the third lens element 130 is f3, the focal length of the first lens element 110 is f1, and they satisfy the relation: f3/f1=0.87.

In the first embodiment of the present optical imaging lens assembly, the distance on the optical axis between the second stop 170 and the electronic sensor is LS, half of the diagonal length of the effective pixel area of the electronic sensor is ImgH, and they satisfy the relation: (ImgH−0.7LS)/ImgH=0.20.

In the first embodiment of the present optical imaging lens assembly, half of the aperture diameter of the second stop 170 is YS, half of the diagonal length of the effective pixel area of the electronic sensor is ImgH, and they satisfy the relation: YS/ImgH=0.43.

In the first embodiment of the present optical imaging lens assembly, the distance on the optical axis between the second stop 170 and the object-side surface 121 of the second lens element 120 is DS, the distance on the optical axis between the object-side surface 121 of the second lens element 120 and the image-side surface 132 of the third lens element 130 is DL, and they satisfy the relation: DS/DL=0.41.

In the first embodiment of the present optical imaging lens assembly, the distance on the optical axis between the object-side surface 111 of the first lens element 110 and the electronic sensor is TTL, half of the diagonal length of the effective pixel area of the electronic sensor is ImgH, and they satisfy the relation: TTL/ImgH =1.76.

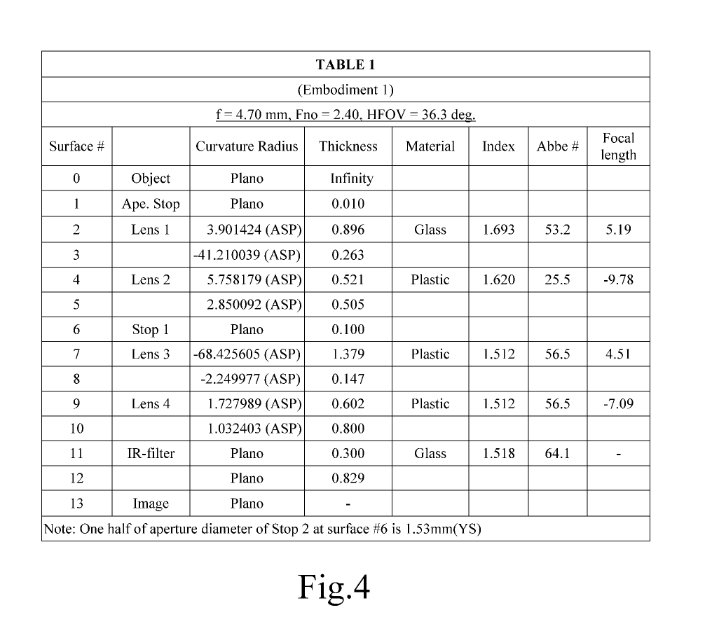

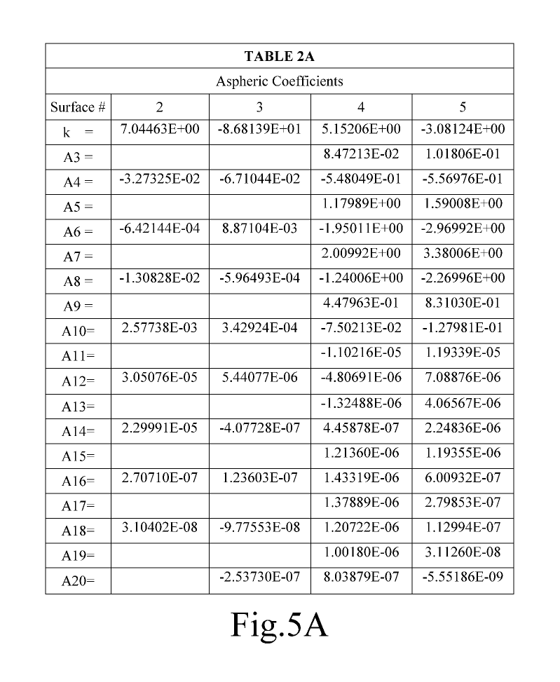

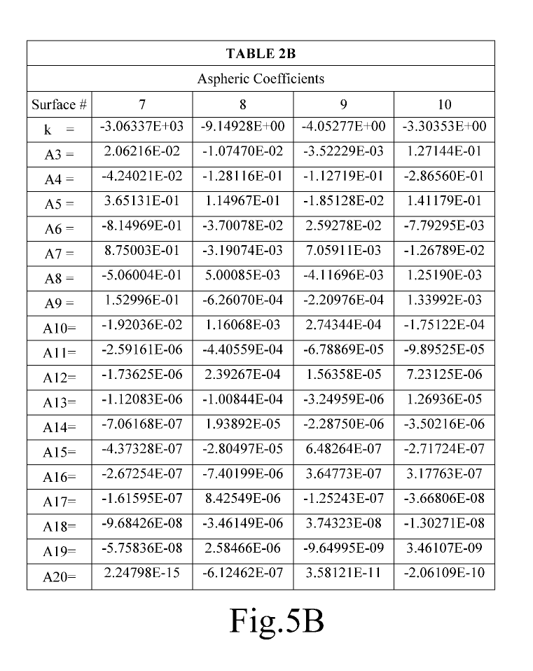

The detailed optical data of the first embodiment is shown in FIG. 4 (TABLE 1), and the aspheric surface data is shown in FIGS. 5A and 5B (TABLES 2A and 2B), wherein the units of the radius of curvature, the thickness and the focal length are expressed in mm, and HFOV is half of the maximal field of view.

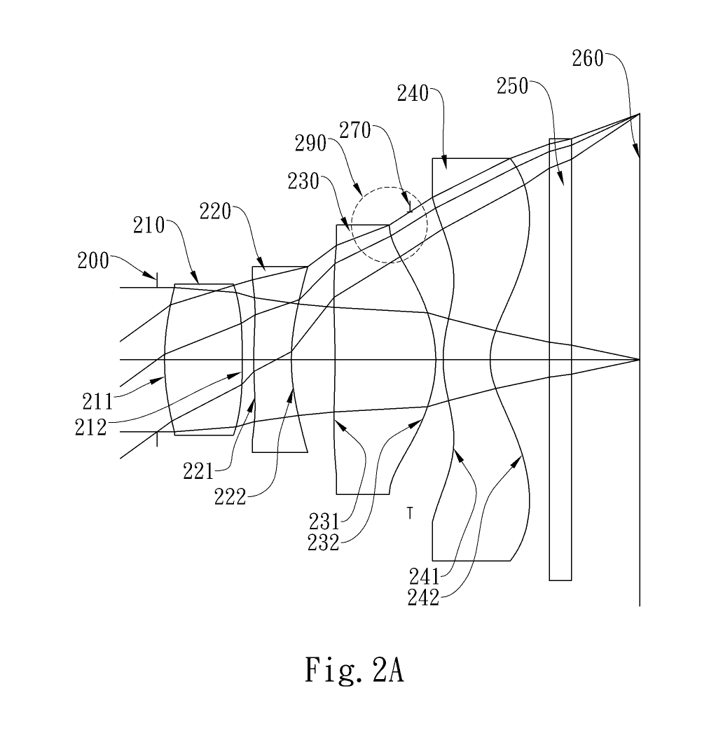

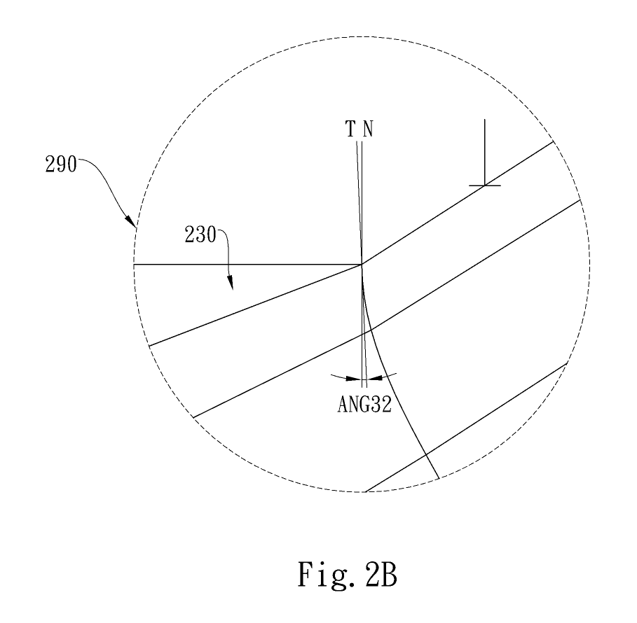

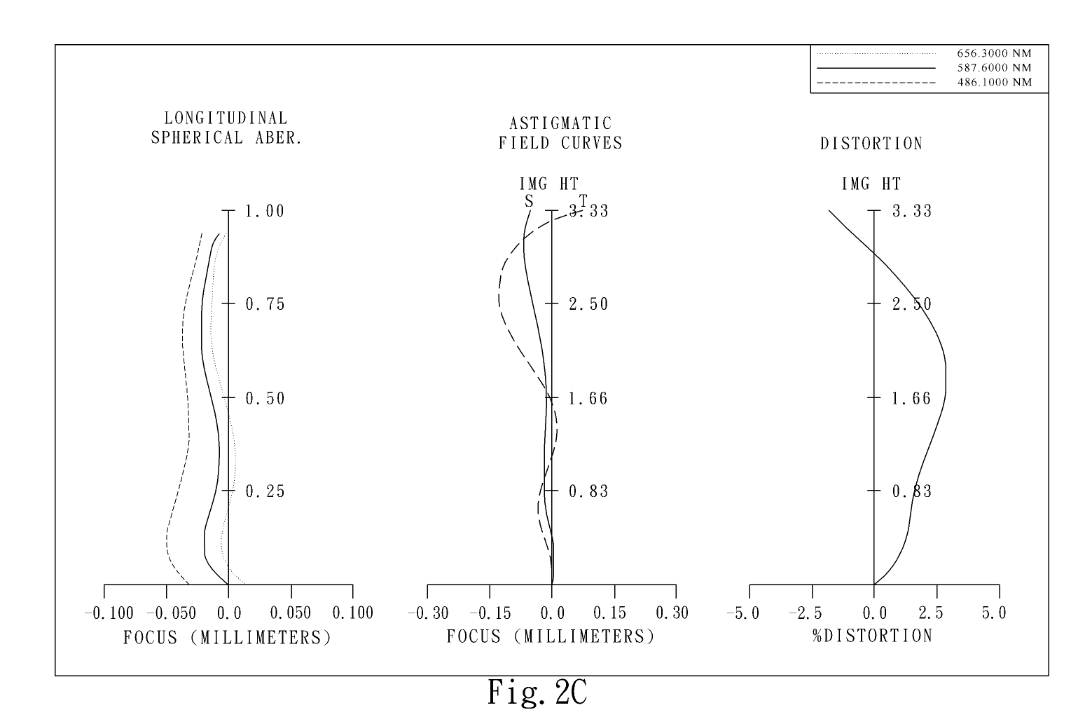

FIG. 2A shows an optical imaging lens assembly in accordance with a second embodiment of the present invention, and FIG. 2C shows the aberration curve of the second embodiment of the present invention. In the second embodiment of the present invention, there is provided an optical imaging lens assembly mainly comprising four lens elements, in order from an object side to an image side: a plastic first lens element 210 with positive refractive power having a convex object-side surface 211 and a convex image-side surface 212, the object-side and image-side surfaces 211 and 212 thereof being aspheric; a plastic second lens element 220 with negative refractive power having a convex object-side surface 221 on which at least one inflection point is formed and a concave image-side surface 222, the object-side and image-side surfaces 221 and 222 thereof being aspheric; a plastic third lens element 230 with positive refractive power having a concave object-side surface 231 and a convex image-side surface 232 on which at least one inflection point is formed, the object-side and image-side surfaces 231 and 232 thereof being aspheric, the edge of the image-side surface 232 of the third lens element 230 within the clear aperture diameter tends to the image side surface (see FIG. 2B and the following description); a plastic fourth lens element 240 with negative refractive power having a convex object-side surface 241 and a concave image-side surface 242, the object-side and image-side surfaces 241 and 242 thereof being aspheric and each of which being provided with at least one inflection point. The optical imaging lens assembly is also provided with an aperture stop 200 disposed between an object and the first lens element 210 and a second stop 270 disposed between the third lens element 230 and the fourth lens element 240. The optical imaging lens assembly further comprises an IR-filter 250 disposed between the image-side surface 242 of the fourth lens element 240 and an image plane 260; the IR-filter 250 is made of glass and has no influence on the focal length of the optical imaging lens assembly. Moreover, an electronic sensor is disposed at the image plane 260 where the object is imaged.

The equation of the aspheric surface profiles of the second embodiment has the same form as that of the first embodiment.

In the second embodiment of the present optical imaging lens assembly, the focal length of the optical imaging lens assembly is f, and it satisfies the relation: f=4.71 (mm).

In the second embodiment of the present optical imaging lens assembly, the f-number of the optical imaging lens assembly is Fno, and it satisfies the relation: Fno=2.40.

In the second embodiment of the present optical imaging lens assembly, half of the maximal field of view of the optical imaging lens assembly is HFOV, and it satisfies the relation: HFOV=36.0 (degrees).

In the second embodiment of the present optical imaging lens assembly, the Abbe number of the first lens element 210 is V1, the Abbe number of the second lens element 220 is V2, and they satisfy the relation: V1−V2=29.9.

In the second embodiment of the present optical imaging lens assembly, the distance on the optical axis between the first lens element 210 and the second lens element 220 is T12, the thickness of the second lens element 220 on the optical axis is CT2, and they satisfy the relation: T12/CT2=0.30.

In the second embodiment of the present optical imaging lens assembly, the radius of curvature of the object-side surface 211 of the first lens element 210 is R1, the radius of curvature of the image-side surface 212 of the first lens element 210 is R2, and they satisfy the relation: R1/R2=−0.26.

In the second embodiment of the present optical imaging lens assembly, the radius of curvature of the object-side surface 221 of the second lens element 220 is R3, the radius of curvature of the image-side surface 222 of the second lens element 220 is R4, and they satisfy the relation: R3/R4=2.17.

In the second embodiment of the present optical imaging lens assembly, the focal length of the first lens element 210 is f1, the focal length of the optical imaging lens assembly is f, and they satisfy the relation: f1/f=1.06.

In the second embodiment of the present optical imaging lens assembly, the focal length of the third lens element 230 is f3, the focal length of the optical imaging lens assembly is f, and they satisfy the relation: f3/f=0.85.

In the second embodiment of the present optical imaging lens assembly, the focal length of the third lens element 230 is f3, the focal length of the first lens element 210 is f1, and they satisfy the relation: f3/f1=0.81.

In the second embodiment of the present optical imaging lens assembly, the distance on the optical axis between the second stop 270 and the electronic sensor is LS, half of the diagonal length of the effective pixel area of the electronic sensor is ImgH, and they satisfy the relation: (ImgH−0.7LS)/ImgH=0.37.

In the second embodiment of the present optical imaging lens assembly, half of the aperture diameter of the second stop 270 is YS, half of the diagonal length of the effective pixel area of the electronic sensor is ImgH, and they satisfy the relation: YS/ImgH=0.60.

In the second embodiment of the present optical imaging lens assembly, the distance on the optical axis between the second stop 270 and the object-side surface 231 of the third lens element 230 is DS, the distance on the optical axis between the object-side surface 231 of the third lens element 230 and the image-side surface 242 of the fourth lens element 240 is DL, and they satisfy the relation: DS/DL=0.48.

In the second embodiment of the present optical imaging lens assembly, the distance on the optical axis between the object-side surface 211 of the first lens element 210 and the electronic sensor is TTL, half of the diagonal length of the effective pixel area of the electronic sensor is ImgH, and they satisfy the relation: TTL/ImgH=1.90.

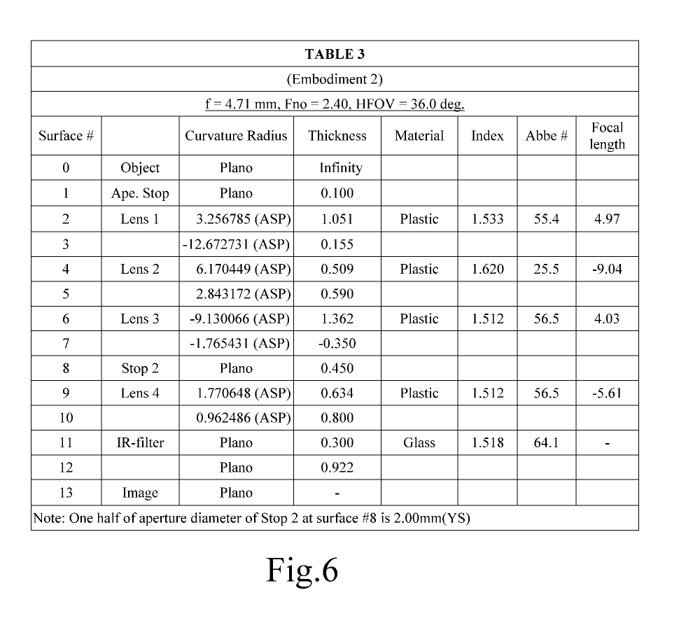

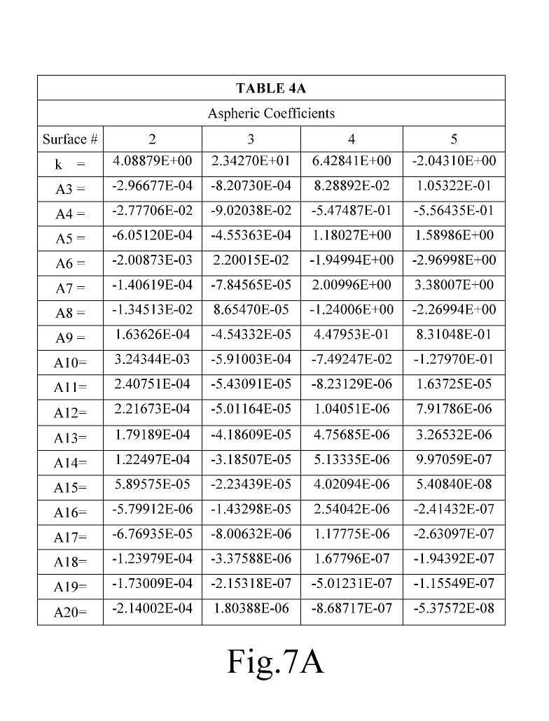

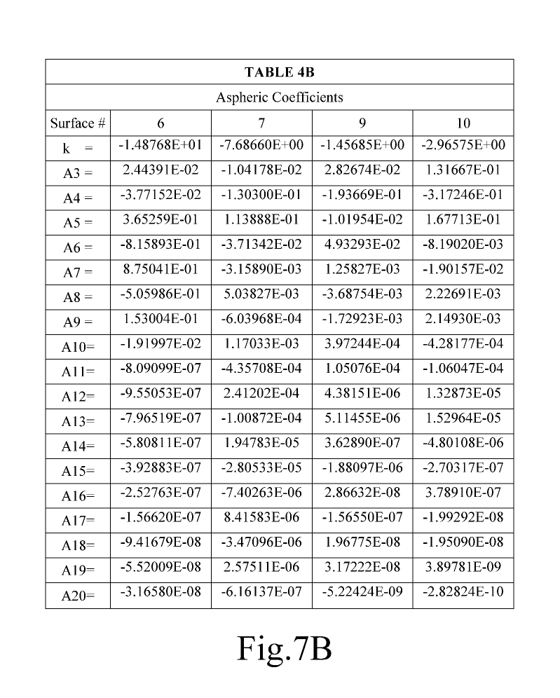

The detailed optical data of the second embodiment is shown in FIG. 6 (TABLE 3), and the aspheric surface data is shown in FIGS. 7A and 7B (TABLES 4A and 4B), wherein the units of the radius of curvature, the thickness and the focal length are expressed in mm, and HFOV is half of the maximal field of view.

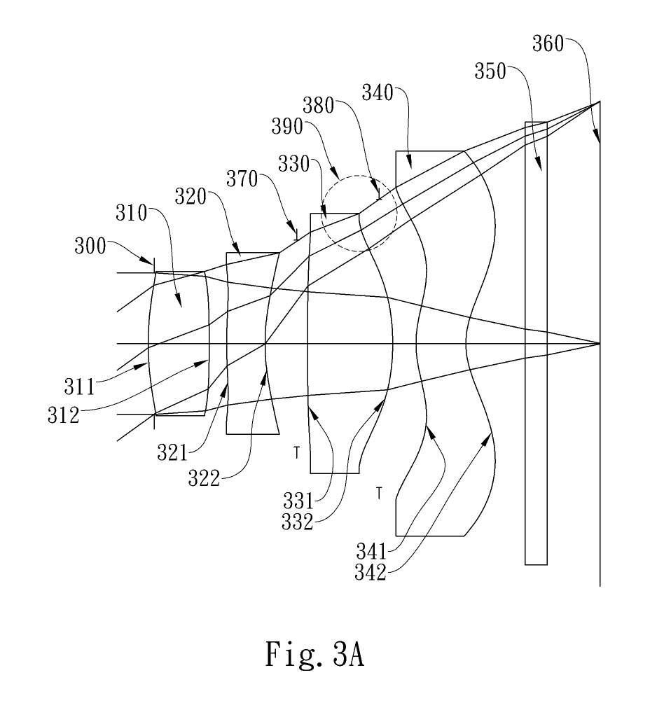

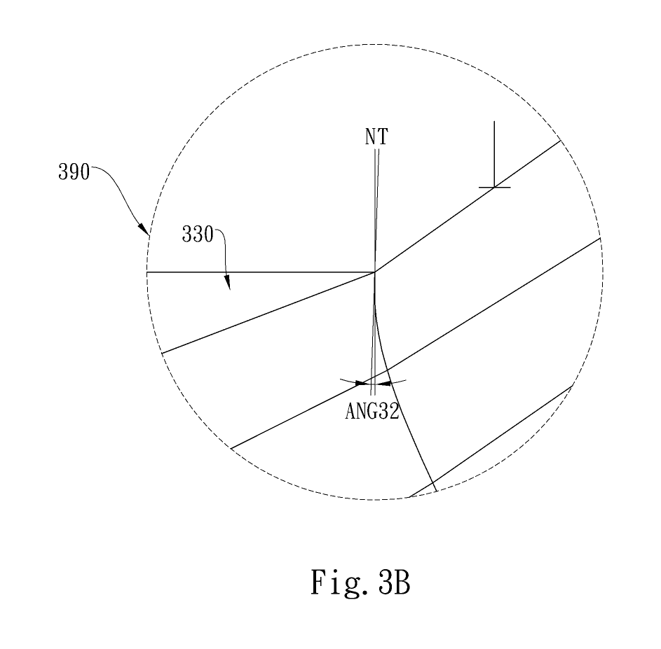

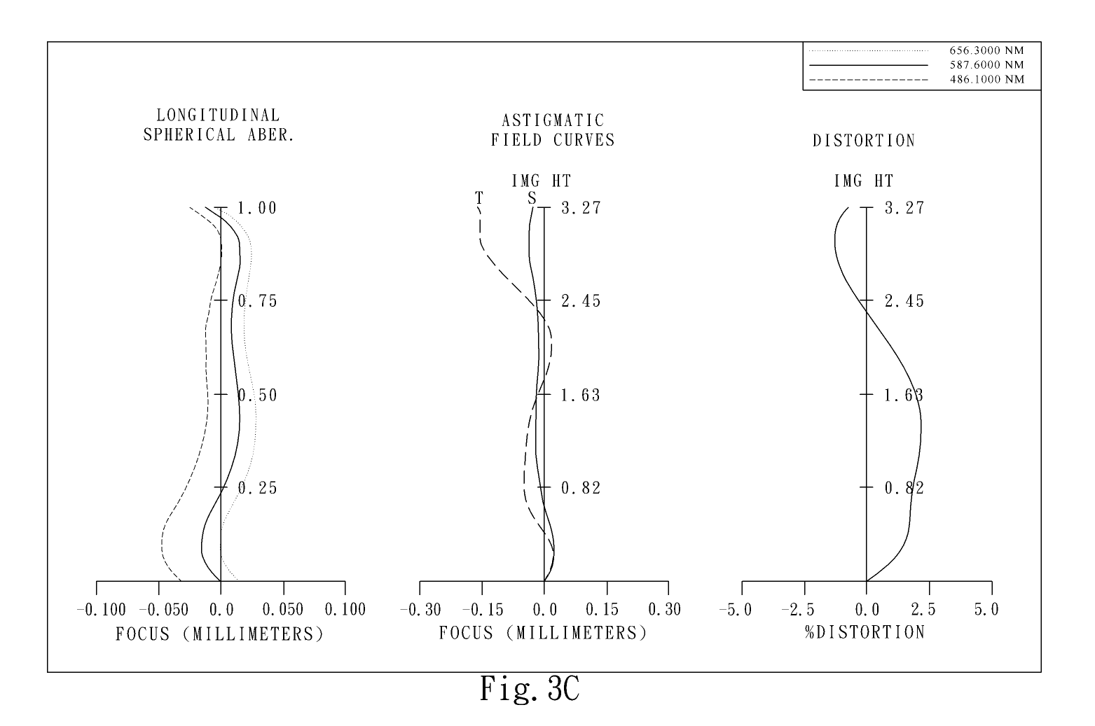

FIG. 3A shows an optical imaging lens assembly in accordance with a third embodiment of the present invention and FIG. 3C shows the aberration curve of the third embodiment of the present invention. In the third embodiment of the present invention, there is provided an optical imaging lens assembly mainly comprising four lens elements, in order from an object side to an image side: a glass first lens element 310 with positive refractive power having a convex object-side surface 311 and a convex image-side surface 312, the object-side and image-side surfaces 311 and 312 thereof being aspheric; a plastic second lens element 320 with negative refractive power having a convex object-side surface 321 on which at least one inflection point is formed and a concave image-side surface 322, the object-side and image-side surfaces 321 and 322 thereof being aspheric; a plastic third lens element 330 with positive refractive power having a concave object-side surface 331 and a convex image-side surface 332, the object-side and image-side surfaces 331 and 332 thereof being aspheric, the edge of the image-side surface 332 of the third lens element 330 within the clear aperture diameter tends to the image side surface (see FIG. 3B and the following description); a plastic fourth lens element 340 with negative refractive power having a convex object-side surface 341 and a concave image-side surface 342, the object-side and image-side surfaces 341 and 342 thereof being aspheric and each of which being provided with at least one inflection point; The optical imaging lens assembly is also provided with an aperture stop 300 disposed between an object and the first lens element 310; a second stop 370 disposed between the second lens element 320 and the third lens element 330; a third stop 380 disposed between the third lens element 330 and the fourth lens element 340; The optical imaging lens assembly further comprises an IR-filter 350 disposed between the image-side surface 342 of the fourth lens element 340 and an image plane 360; the IR-filter 350 is made of glass and has no influence on the focal length of the optical imaging lens assembly. Moreover, an electronic sensor is disposed at the image plane 360 where the object is imaged.

The equation of the aspheric surface profiles of the third embodiment has the same form as that of the first embodiment.

In the third embodiment of the present optical imaging lens assembly, the focal length of the optical imaging lens assembly is f, and it satisfies the relation: f=4.61 (mm).

In the third embodiment of the present optical imaging lens assembly, the f-number of the optical imaging lens assembly is Fno, and it satisfies the relation: Fno=2.40.

In the third embodiment of the present optical imaging lens assembly, half of the maximal field of view of the optical imaging lens assembly is HFOV, and it satisfies the relation: HFOV=35.8 (degrees).

In the third embodiment of the present optical imaging lens assembly, the Abbe number of the first lens element 310 is V1, the Abbe number of the second lens element 320 is V2, and they satisfy the relation: V1−V2=27.7.

In the third embodiment of the present optical imaging lens assembly, the distance on the optical axis between the first lens element 310 and the second lens element 320 is T12, the thickness of the second lens element 320 on the optical axis is CT2, and they satisfy the relation: T12/CT2=0.45.

In the third embodiment of the present optical imaging lens assembly, the radius of curvature of the object-side surface 311 of the first lens element 310 is R1, the radius of curvature of the image-side surface 312 of the first lens element 310 is R2, and they satisfy the relation: R1/R2=−0.06.

In the third embodiment of the present optical imaging lens assembly, the radius of curvature of the object-side surface 321 of the second lens element 320 is R3, the radius of curvature of the image-side surface 322 of the second lens element 320 is R4, and they satisfy the relation: R3/R4=2.07.

In the third embodiment of the present optical imaging lens assembly, the focal length of the first lens element 310 is f1, the focal length of the optical imaging lens assembly is f, and they satisfy the relation: f1/f=1.11.

In the third embodiment of the present optical imaging lens assembly, the focal length of the third lens element 330 is f3, the focal length of the optical imaging lens assembly is f, and they satisfy the relation: f3/f=1.81.

In the third embodiment of the present optical imaging lens assembly, the focal length of the third lens element 330 is f3, the focal length of the first lens element 310 is f1, and they satisfy the relation: f3/f1=1.63.

In the third embodiment of the present optical imaging lens assembly, the distance on the optical axis between the second stop 370 and the electronic sensor is LS, half of the diagonal length of the effective pixel area of the electronic sensor is ImgH, and they satisfy the relation: (ImgH−0.7LS)/ImgH=0.14.

In the third embodiment of the present optical imaging lens assembly, half of the aperture diameter of the second stop 370 is YS, half of the diagonal length of the effective pixel area of the electronic sensor is ImgH, and they satisfy the relation: YS/ImgH=0.43.

In the third embodiment of the present optical imaging lens assembly, the distance on the optical axis between the second stop 370 and the object-side surface 321 of the second lens element 320 is DS, the distance on the optical axis between the object-side surface 321 of the second lens element 320 and the image-side surface 332 of the third lens element 330 is DL, and they satisfy the relation: DS/DL=0.42.

In the third embodiment of the present optical imaging lens assembly, the distance on the optical axis between the third stop 380 and the electronic sensor is LS, half of the diagonal length of the effective pixel area of the electronic sensor is ImgH, and they satisfy the relation: (ImgH−0.7LS)/ImgH=0.38.

In the third embodiment of the present optical imaging lens assembly, half of the aperture diameter of the third stop 380 is YS, half of the diagonal length of the effective pixel area of the electronic sensor is ImgH, and they satisfy the relation: YS/ImgH=0.60.

In the third embodiment of the present optical imaging lens assembly, the distance on the optical axis between the third stop 380 and the object-side surface 331 of the third lens element 330 is DS, the distance on the optical axis between the object-side surface 331 of the third lens element 330 and the image-side surface 342 of the fourth lens element 340 is DL, and they satisfy the relation: DS/DL=0.45.

In the third embodiment of the present optical imaging lens assembly, the distance on the optical axis between the object-side surface 311 of the first lens element 310 and the electronic sensor is TTL, half of the diagonal length of the effective pixel area of the electronic sensor is ImgH, and they satisfy the relation: TTL/ImgH=1.84.

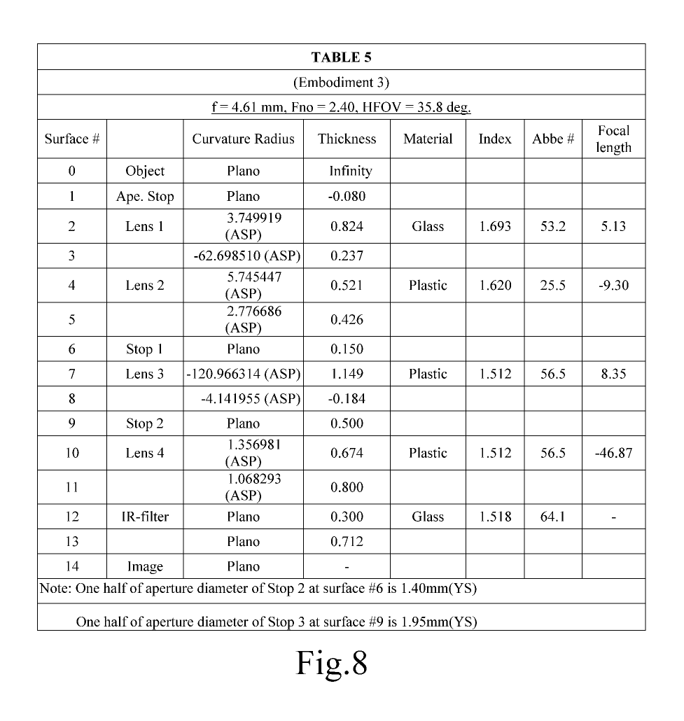

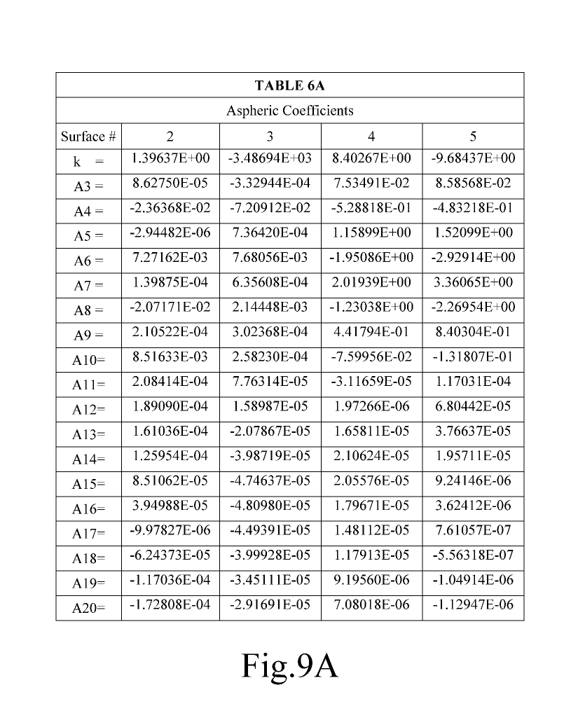

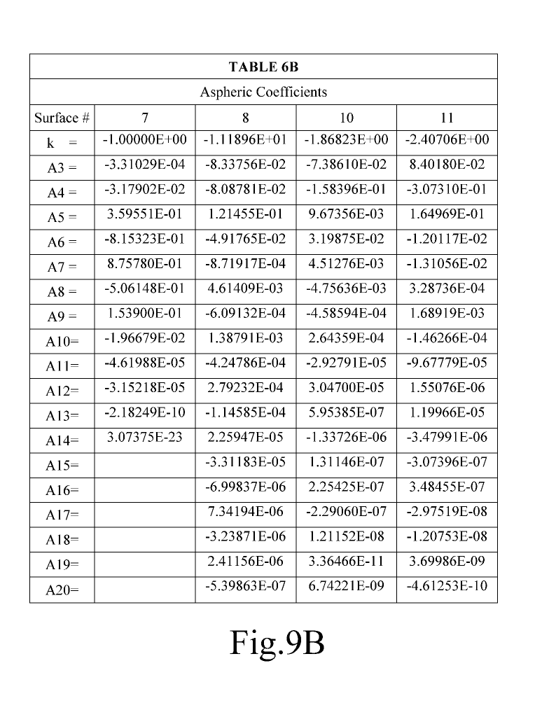

The detailed optical data of the third embodiment is shown in FIG. 8 (TABLE 5), and the aspheric surface data is shown in FIGS. 9A and 9B (TABLES 6A and 6B), wherein the units of the radius of curvature, the thickness and the focal length are expressed in mm, and HFOV is half of the maximal field of view.

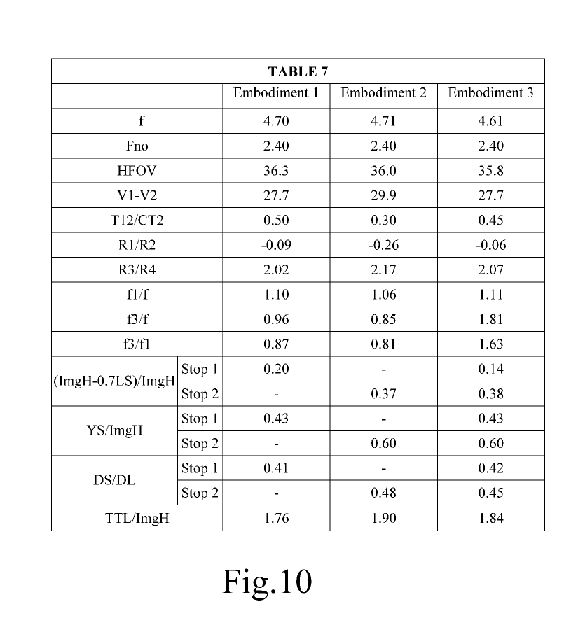

It is to be noted that TABLES 1-6 (illustrated in FIGS. 4-9 respectively) show different data of the different embodiments, however, the data of the different embodiments are obtained from experiments. Therefore, any optical imaging lens assembly of the same structure is considered to be within the scope of the present invention even if it uses different data. The embodiments depicted above and the appended drawings are exemplary and are not intended to limit the scope of the present invention. TABLE 7 (illustrated in FIG. 10) shows the data of the respective embodiments resulting from the equations.

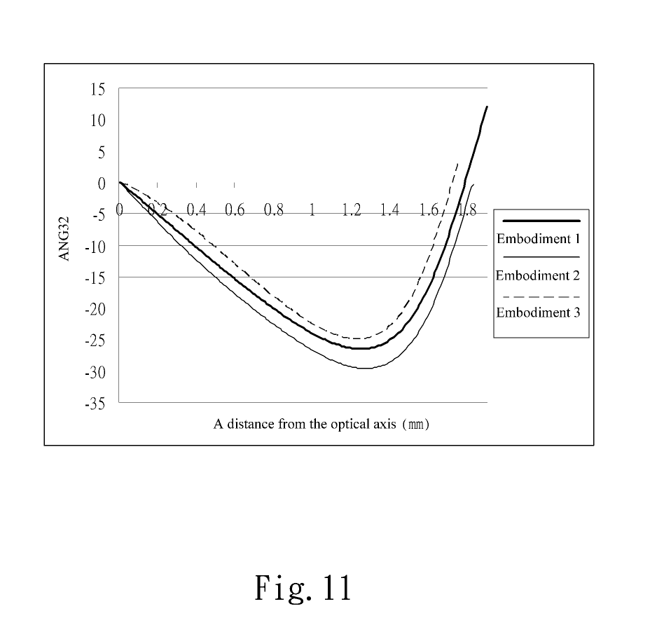

FIG. 11 shows the relation between the clear aperture diameter of the image-side surface of the third lens element and the tangential angle (ANG32) in accordance with the first, second and third embodiments. FIGS. 1B, 2B and 3B are enlarged views showing the edges (190, 290, 390) of the image-side surfaces (132, 232, 332) of the third lens elements (130, 230, 330) within the clear aperture diameter in accordance with the first, second and third embodiments, respectively.

In the aforementioned optical imaging lens assembly, the farthest point of the effective area of the image-side surface that allows incoming light to pass through the third lens element is the position of the clear aperture diameter; a tangential plane is tangent to the image-side surface of the third lens element at the position of the clear aperture diameter; a plane intersects the image-side surface of the third lens element at the position of the clear aperture diameter and is perpendicular to the optical axis; the angle between the tangential plane and the plane is a tangential angle, ANG32, at the position of the clear aperture diameter of the image-side surface of the third lens element. When the intersection of the plane and the optical axis is closer to the object side than the intersection of the tangential plane and the optical axis, ANG32 is negative. When the intersection of the plane and the optical axis is farther away from the object side than the intersection of the tangential plane and the optical axis, ANG32 is positive.

What is claimed is:

1. An optical imaging lens assembly comprising, in order from an object side to an image side:
a first lens element with positive refractive power having a convex object-side surface;
a second lens element with negative refractive power having a convex object-side surface and a concave image-side surface;
a third lens element having a convex image-side surface, a edge of the image-side surface of the third lens element within a clear aperture diameter tends to the image side;
a fourth lens element with negative refractive power having a concave image-side surface;
a first stop disposed between an object and the first lens element; and
a second stop disposed between the second and fourth lens elements; wherein the optical imaging lens assembly further comprises an electronic sensor where the object is imaged; wherein a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is LS, half of an aperture diameter of the second stop is YS, a distance on the optical axis between the second stop and an object-side surface of an adjacent lens element relative to the object side of the second stop is DS, a distance on the optical axis between the object-side surface of an adjacent lens element relative to the object side of the second stop and an image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations:
(ImgH-0.7LS)/ImgH<YS/ImgH<0.78;
0.1<DS/DL<0.7;
0.63<f3/f1<2.45;
V1−V2>25.6;
0.15<T12/CT2<1.95; and
0.67<f3/f<3.33.

2. The optical imaging lens assembly according to claim 1, wherein the first stop is an aperture stop, at least one of the object-side and image-side surfaces of the fourth lens element is aspheric, and at least one of the object-side and image-side surfaces of the fourth lens element is provided with at least one inflection point.

3. The optical imaging lens assembly according to claim 2, wherein a radius of curvature of the object-side surface of the second lens element is R3, a radius of curvature of the image-side surface of the second lens element is R4, and they satisfy the relation: 1.5<R3/R4<2.5.

4. The optical imaging lens assembly according to claim 3, wherein a radius of curvature of the object-side surface of the first lens element is R1, a radius of curvature of an image-side surface of the first lens element is R2, and they satisfy the relation: −1<R1/R2<0.

5. The optical imaging lens assembly according to claim 3, wherein the focal length of the first lens element is f1, the focal length of the optical imaging lens assembly is f, and they satisfy the relation: 1.05<f1/f<1.18.

6. The optical imaging lens assembly according to claim 1, wherein the first stop is an aperture stop, and at least one of the object-side and image-side surfaces of the second lens element is provided with at least one inflection point.

7. The optical imaging lens assembly according to claim 1, wherein the first stop is an aperture stop, and the fourth lens element is made of plastic material, and at least one of the object-side and image-side surfaces thereof is provided with at least one inflection point.

8. The optical imaging lens assembly according to claim 7, wherein a distance on the optical axis between the object-side surface of the first lens element and the electronic sensor is TTL, half of the diagonal length of the effective pixel area of the electronic sensor is ImgH, and they satisfy the relation: TTL/ImgH<2.0.

9. An optical imaging lens assembly comprising, in order from an object side to an image side:
a first lens element with positive refractive power having a convex object-side surface;
a second lens element with negative refractive power having a convex object-side surface and a concave image-side surface;
a third lens element with positive refractive power having a convex image-side surface on which at least one inflection point is formed;
a fourth lens element with negative refractive power having a concave image-side surface;
a first stop disposed between an object and the first lens element; and
a second stop disposed between the second and third lens elements; wherein the optical imaging lens assembly further comprises an electronic sensor where the object is imaged; wherein a focal length of the optical imaging lens assembly is f, a focal length of the first lens element is f1, a focal length of the third lens element is f3, an Abbe number of the first lens element is V1, an Abbe number of the second lens element is V2, a distance on the optical axis between the second stop and the electronic sensor is LS, half of an aperture diameter of the second stop is YS, a distance on the optical axis between the second stop and an object-side surface of an adjacent lens element relative to the object side of the second stop is DS, a distance on the optical axis between the object-side surface of an adjacent lens element relative to the object side of the second stop and an image-side surface of an adjacent lens element relative to the image side of the second stop is DL, a distance on the optical axis between the first and second lens elements is T12, a thickness of the second lens element on the optical axis is CT2, half of a diagonal length of an effective pixel area of the electronic sensor is ImgH, and they satisfy the relations:
(ImgH-0.7LS)/ImgH<YS/ImgH<0.78;
0.1<DS/DL<0.7;
0.63<f3/f1<2.45;
V1−V2>25.6;
0.15<T12/CT2<1.95; and
0.67<f3/f <3.33.

10. The optical imaging lens assembly according to claim 9, wherein the first stop is an aperture stop, and the distance on the optical axis between the first and second lens elements is T12, the thickness of the second lens element on the optical axis is CT2, and they satisfy the relation: 0.15<T12/CT2<0.80.

11. The optical imaging lens assembly according to claim 10, wherein a radius of curvature of the object-side surface of the second lens element is R3, a radius of curvature of the image-side surface of the second lens element is R4, and they satisfy the relation: 1.5<R3/R4<2.5.

12. The optical imaging lens assembly according to claim 9, wherein at least one of the object-side and image-side surfaces of the second lens element is provided with at least one inflection point, at least one of the object-side and image-side surfaces of the fourth lens element is provided with at least one inflection point, and the focal length of the first lens element is f1, the focal length of the optical imaging lens assembly is f, and they satisfy the relation: 1.05<f1/f<1.18.
